(19) United States
(12) Patent Application Publication
(10) Pub. No.: US 2007/0085993 A1
(43) Pub. Date: Apr. 19, 2007

(54) Audible distance measurer-object discriminator cognition stimulant system device

(76) Inventor: Robert Brown JR., Warner Robins, GA (US)

Correspondence Address: Robert Brown Jr., 1613 Sweetwater Dr., Warner Robins, GA, 31088, US

(21) Appl. No.: 11/251,506

(22) Filed: Oct. 17, 2005

(51) Int. Cl. G01C 3/00

(52) U.S. Cl. 356/3

(57) ABSTRACT

An audible distance measurer object-face discriminator cognition stimulant system device housed in a handheld shaft, walking stick, belt attachment, or portable housing. The system device will capture, detect, merge, convert, process, compute and/or synthesize signals, measurements, images, objects-faces, colors, and shapes to output assistive phrases and measurements in electronic voice, to inform and make the user knowledgeable of objects and aware of surroundings and environment directly in path of movement-direction pointed, comprising in combination strategically positioned signal receivers, transmitters or satellite, embedded distance measurer sensor, digital video camera, cellular phone, radio, electronic travel aid (ETA), electronic orientation aid (EOA), position locator device (PLD), embedded restroom facility locator sensor, and embedded vehicle presence alert system (VPAS) sensor, which will generally aid sighted and visually impaired students, teachers and students of the No Child Left Behind (NCLB) Act, and more particularly, the elderly, and visually impaired military war veterans in a Right to Personal Privacy, while simultaneously providing sighted and blind-visually impaired children with an educational toy and interactive game.

### TECHNICAL FIELD

This invention relates to an electronic measuring tool with object-face recognition technology. More particularly, relates to an audible distance measurer object-face discriminator cognition stimulant system device with an object-face recognition digital video camera, ultrasonic distance measurer, radio, cellular phone, electronic orientation aid (EOA), electronic travel aid (ETA), restroom-building locator, position locator device (GPS), and vehicle presence alert system (VPAS) embedded in a handheld shaft, walking stick, belt attachment, or portable housing (only the handheld shaft will be displayed) which outputs assistive phrases in electronic voice thereon.

### BACKGROUND OF THE INVENTION

Over the past decades, the teaching-learning tool of choice was a measuring stick or a ruler for basic mathematics. Today's students are grasping computer assisted electronic devices and games which are providing a stimulus to educational instruction. This invention is a culmination of effort to merge technology to achieve higher-order thinking and abstract thought perception and development in students for improving cognition especially with math, while simultaneously enabling sight through audible system devices for the blind/visually impaired or for those having low vision, which will routinely provide personal freedom and optimum mental picture of the environment, better grasp of measurements to an object, a clearer understanding of dimensions-color-size, and shape of an object in the surroundings without actually seeing the face-object and surroundings with eyesight.

A student's ability to become intrinsically involved in a classroom, focused and to learn at a faster pace is sometimes impacted by distractions and intimidations due to boredom, number of students in a classroom and lack of personal attention. Other students will refuse to listen and will block out the lesson being taught in the classroom due to shyness and introversion, which are aggravated by peer pressure, fear and pride. The chief problems that hinders a student's education as reported by the Department of Education are attention, memory, and decision-making.

There is a wide range of books and toys for students to improve intellectual development. Selecting a particular learning tool depends upon the age and needs of the individual and the educational environment in which they live. Our student population rarely start school with the necessary assistive tool or device which will accelerate those in becoming quick study mathematics students and simultaneously mentally challenging them while playing a game. Part of the reason is that educational technology and toy developers have not/are not focused on designing educational tools and devices which are cognitive stimulants and involving abstract thought interaction all-in-one.

Preliminary research with statistical findings at the Department of Education has it that approximately 35-45 percent of U.S. 4^{th} graders cannot read and understand a paragraph in a children's book, therefore, short term and long term mathematics comprehension and reasoning abilities are affected.

During the 90's, TV and newspapers reported that famed blind singer Stevie Wonder voiced a desire to see and other people with a similar visual impairment may have the same desire. Present day cameras and sensors which will facilitate sight through means of using electronics are scattered and segmented throughout the consumer electronics industry in numerous and in separate devices.

Existing mobility aids are found in four types and have a limiting disadvantage such as the following: human guide in which the user develops dependency and is harmful to self reliance; walking cane in which a potential problem exists with pedestrians accidentally tripping; dog guide in which personal attachment causes distress when loss or death occurs; and electronic travel aids (ETA) in which a wear out replacement factor exist in weatherproofing gaskets which are used to seal components from various elements of weather.

Pedestrians, the elderly and disabled-visually impaired persons fall prey to regular motor vehicle and emergency motor vehicle accidents at intersections every year due to a lack of advance sight and sound notifications.

Additionally, some military blind-disabled veterans, elderly and other persons often require a restroom stop while traveling-walking down the street thus have a legitimate Right To Personal Privacy-Disability Act Concern due to an absence of a developed restroom facility locator system or homing device. The present invention claimed herein will overcome the above situations and disadvantages.

### BRIEF SUMMARY OF THE INVENTION

In view of the above, the present invention is presented to accomplish multiple objectives and advantages, including successfully addressing the shortcomings of the presently known tools/aids, by providing a solution relating to any student, visually impaired disabled military veteran and others, or an elderly person's situation and experience, such as the following:

It is an advantage and object of the present invention to aid teachers i.e. a teaching aid/tool to teach measurements-mathematics to grade school children to improve cognition. A system device for a child student will measure the distance to an object in inches, feet, or meters and provide a description of the object in electronic voice while the student performs hands-on measurements-mathematics problems and develops critical solutions as a result of hearing, and simultaneously the teacher will become more innovative.

It is another advantage and object of the present invention to output in electronic voice the measured distance to an object directly in path of movement, for allowing a collision avoidance tool for the blind-visually impaired which will reduce and prevent bumping and stumbling into and tripping over an object, thus will stimulate memory, attention, and decision-making.

It is still another advantage and object of the present invention to provide an educational home-school classroom-playground toy and interactive game, which can be played by sighted and blind-visually impaired children and 35-45% of U.S. 4^{th} Graders with a reading comprehension difficulty/deficiency. The object of the educational interactive game called “Depth Perception” (game formerly called Blind Man's Bluff), is to determine who has the better skill of sensing a measured distance to an object without eyesight (i.e. with eyes blindfolded) within 60 seconds or in a pre-determined allotted time. The present invention allows for two competing individuals or a competing team of two or more sighted or visually impaired persons to challenge their comprehension, higher-order thinking and self development skills. To play the interactive game, a player will use a system device while blindfolded, perception, hearing, and be able to understand and mentally visualize a description of a detected object's dimension, shape, size, color, and measured distance in feet, inches or meters to an object, which are output in a phrase in electronic voice. The system device will detect the object, provide a measured distance to the object, and describe the object, while the player simultaneously moves forward, backward, or side to side the measured distance to achieve the game's competitive objective. Competing students will shout measurements and directions in an attempt to disrupt the player's attention, memory, and decision-making ability. The detected object is moved once (three) feet or a pre-determined and announced distance from the object's detected location (i.e. moved back, up, or down) to provide a significant challenge and timed hurdle—the player is informed of the moved distance but not of the location. The person or team which moves closest to the object in the allotted time, will determine having the greater sensing ability.

It is a further advantage and object of the present invention to provide an all-in-one toy having a radio and cellular phone, a vehicle presence alert sensor (VPAS), educational aid, visual guide, and physical exercise stimulant tool containing GPS, for achieving entertainment, communication, safety, and scholastic development indoors and outdoors.

It is yet a further advantage and object of the present invention to output the phrase “emergency vehicle approaching the vicinity” in electronic voice, for allowing an advance warning safety alert notification. According to the National Highway Transportation Association (NHTA), “accidents at intersections between motor vehicles and pedestrians (approximately 5000 per year) are at an alarmingly high rate (12-17%) of total motor vehicle accidents, and are due primarily to insufficient advance warning notification of arrival of emergency vehicle i.e. sight and sound issues.

It is still a further advantage and object of the present invention to detect the nearest building-restroom location to provide additional personal freedom for privacy and to output a phrase having the location and distance-direction to nearest building-restroom facility, in electronic voice. Some elderly, disabled and blind-visually-impaired individuals need/require a restroom stop while traveling-walking down the street—they request-shout for help-assistance-directions to the nearest restroom facility-location which goes unanswered from people in the vicinity, and relieve themselves in public in their clothes—a preventable Right To Personal Privacy-Disability Act Concern.

It is yet another advantage and object of the present invention to compliment, supplement and reinforce the white cane, guide dog and guide person by outputting an assistive phrase in electronic voice having a description of an object and measured distance to the object, and without a requirement of human, animal, or eyesight assistance.

It is another advantage and object of the present invention to serve as training aid and medical system device-tool for diabetics with low and no vision and individuals with retina problems, which can be used as a forerunner system device that will aid in preparation for loss of sight to lessen the ordeal and effects of being-feeling empty, totally isolated and feeling alone. The system device, also will serve others as sight replacement or a substitute for eyesight.

It is yet another advantage and object of the present invention to detect, merge, convert, synthesize, compute, translate, or process as output in electronic voice a phrase containing the detected object-face description, shape, color, and dimension and measured distance to the object captured with embedded digital video camera and detected with embedded sensors attached thereon, to provide knowledge and awareness of objects and surroundings and environment directly in path of movement-direction pointed to reduce aloofness, and to prevent stumbling and tripping over an object directly in path of movement. The system device allows for an additional ounce of enjoyment of life for greater independence. The intended users are the well educated-technology driven visually disabled military war veterans, sighted and visually impaired students, children, any adult, any age or gender.

### DESCRIPTION OF THE SEVERAL VIEWS OF THE DRAWING(S).

The invention is herein described, by way of example only, with reference to the accompanying drawings, wherein:

FIG. 1, FIG. 1A, FIG. 1B, FIG. 1C, and FIG. 1D illustrates the embodiment of the system device.

FIG. 2 illustrates advance notification of emergency vehicle presence early warning.

FIG. 3 illustrates preferred embodiment of transmitter and sensor locator to existing building with restroom.

FIG. 4 illustrates preferred embodiment for guidance advisor and aid to safety.

FIG. 5 illustrates a preferred embodiment at an intersection.

### DETAILED DESCRIPTION OF THE INVENTION.

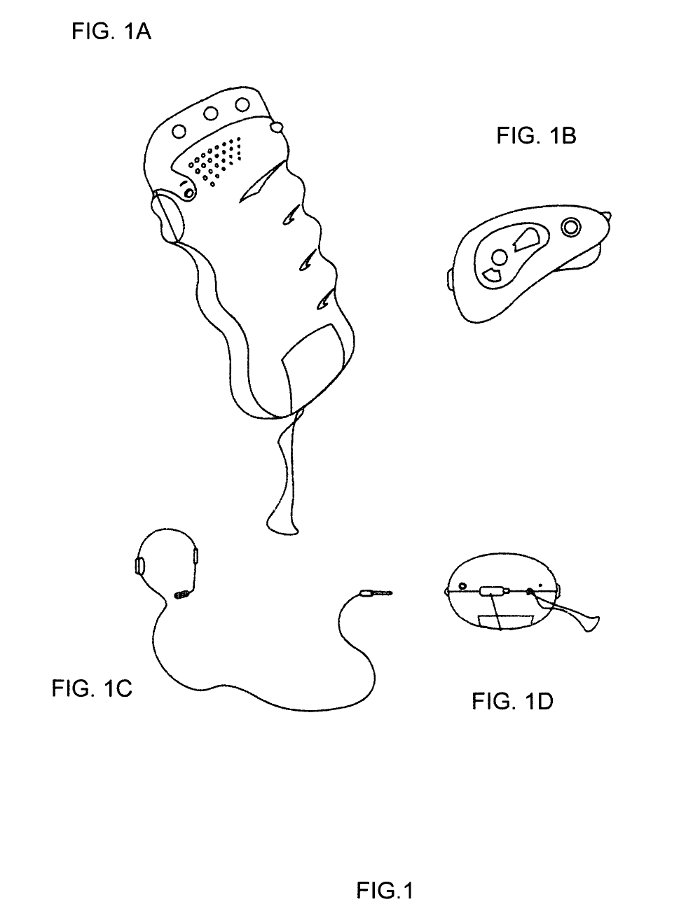

Referring to drawings in greater detail, FIG. 1, FIG. 1A1, FIG. 1B2, FIG. 1C3, and FIG. 1D4 provides views of the embodiment of an audible distance measurer object-face discriminator cognition stimulant system device 1 that can be used by children, adults, disabled blind-vision impaired military veterans, elderly, or sighted and visually impaired mathematics students/medical patients. An audible distance measurer object-face discriminator cognition stimulant system device 1 will typically comprise of a shaft 2 speaker 6 with portal attachment 4 for headphones 5; embedded distance measurer sensor 17 echo cone 9, which receives signals back from an object located directly in path of movement where pointed; radio and a voice dial cellular phone with antennae 15 attached to shaft 2 forward end; embedded object-face recognition video camera 8, embedded vehicle presence alert system (VPAS) sensor 12 for allowing advance warning and notification of emergency vehicle/any vehicle approaching the vicinity, which is used in combination with a vehicle mounted VPAS transmitter, electronic orientation aid (EOA), electronic travel aid (ETA) for allowing awareness of day, date, temperature, and time, embedded GPS sensor 13, embedded restroom-building locator sensor 14, for allowing detection of transmitter signals from a building-location with the nearest restroom facility; and synthesizer, processor-computer attached therein for allowing captured measurements and videoed images of color, shape and size to/of a detected object-face to output as a phrase and in electronic voice, to inform and make the user aware of surroundings and of objects in the environment.

FIG. 1 illustrates system device 1 with speaker 6 and earphone jack 4 with earphone 5 which allows for audible electronic voice output in assistive phrases. Battery(s) in compartment 10 operates system device 1 with portal 16 for allowing recharging the operating battery(s). Wrist strap 11 wraps around user wrist for allowing control and handling and power switch 3 for allowing on/off power. Shaft 2 allows for embedding, gripping, pointing, and controlling. Trigger finger selector switch 7 simultaneously engages attached sensors with video camera, which automatically preempts day, date, phone, radio, and time of day output.

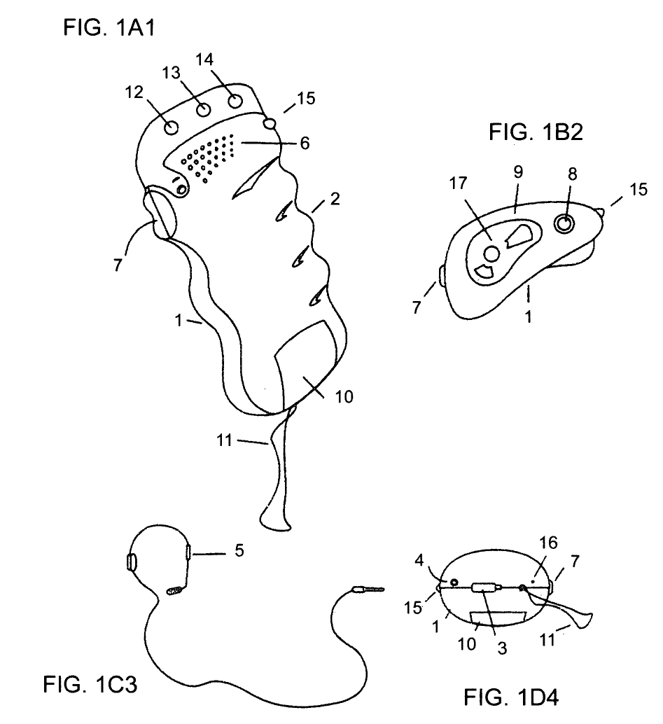

FIG. 2 illustrates system device 1 having detected a vehicle presence alert system “VPAS” transmitter signal from an approaching ambulance by satellite or ground relay, for allowing converting, computing, synthesizing, or processing to output the assistive phrase “emergency vehicle approaching vicinity” in electronic voice—for allowing an advance safety early alert notification. The vehicle presence alert system (VPAS) sensor allows motorcycles and emergency vehicles (ambulances-police-fire) to transmit signals to system device 1 and to other vehicle(s) in proximity, thus transmits an audible early warning of motorcycle and emergency vehicle presence-notification solution for ERT, DoD, General Public, and DOT—and is a dual-use communications initiative. This initiative will maximize driver notification and proximity warning of motorcycles with accuracy and efficiency by reducing and eliminating pedestrians and motorists lack of “sight and sound” factors at intersections, cross-walks, and on the open highway. FIG. 2 also illustrates GPS signal to track location.

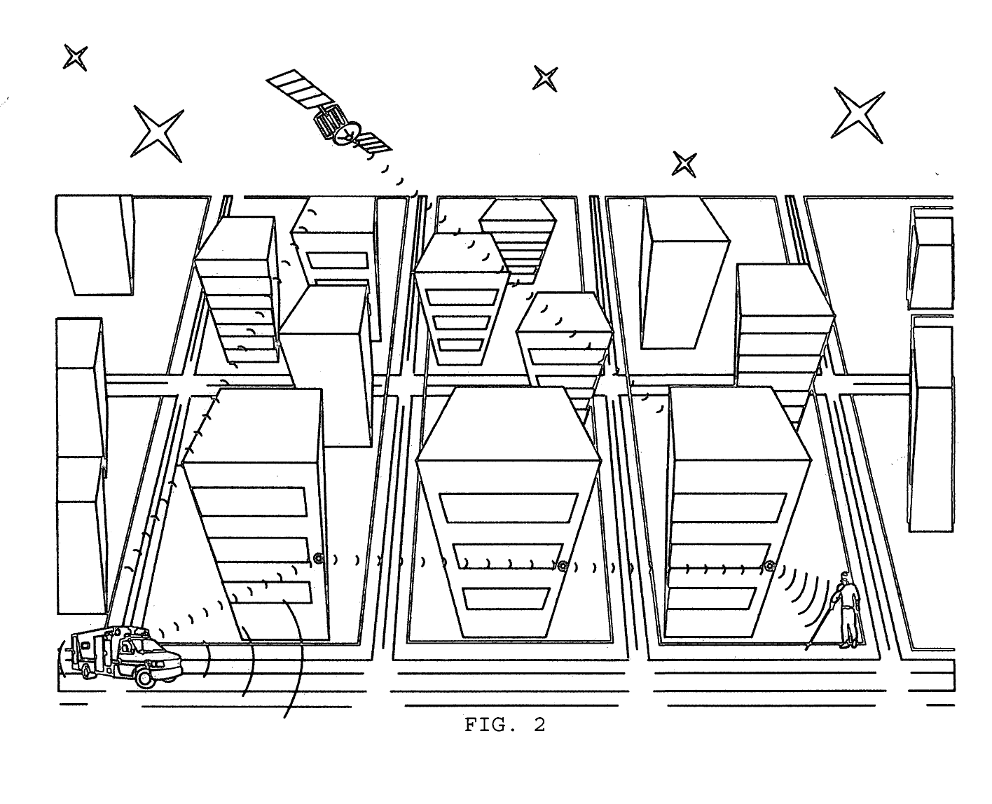

FIG. 3 illustrates system device 1 having detected a restroom-building transmitter signal, with restroom locator sensor 14 attached thereon, for allowing computer, synthesizer, converter or processor attached therein to output a location and measured distance-direction to nearest building with a restroom, in electronic voice.

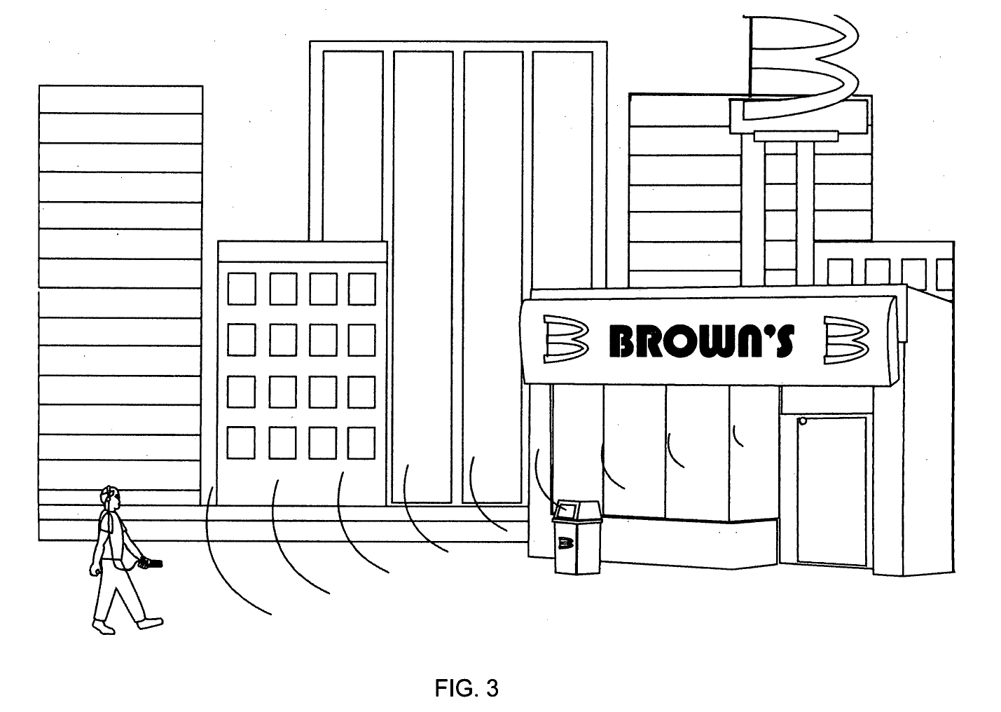

FIG. 4 illustrates system device 1 having a digital object-face recognition video camera 8 and ultrasonic distance measurer sensor 17 attached thereon, for allowing captured color, size, image of an object and measured distance to an object directly in path of movement-direction pointed to merge, convert, synthesize, compute, or process as output as a phrase in electronic voice the object description and measured distance to the object for a safety warning in maneuvering around and over an object, and down and up a flight of stairs, thus will provide knowledge and awareness of objects to better navigate surroundings.

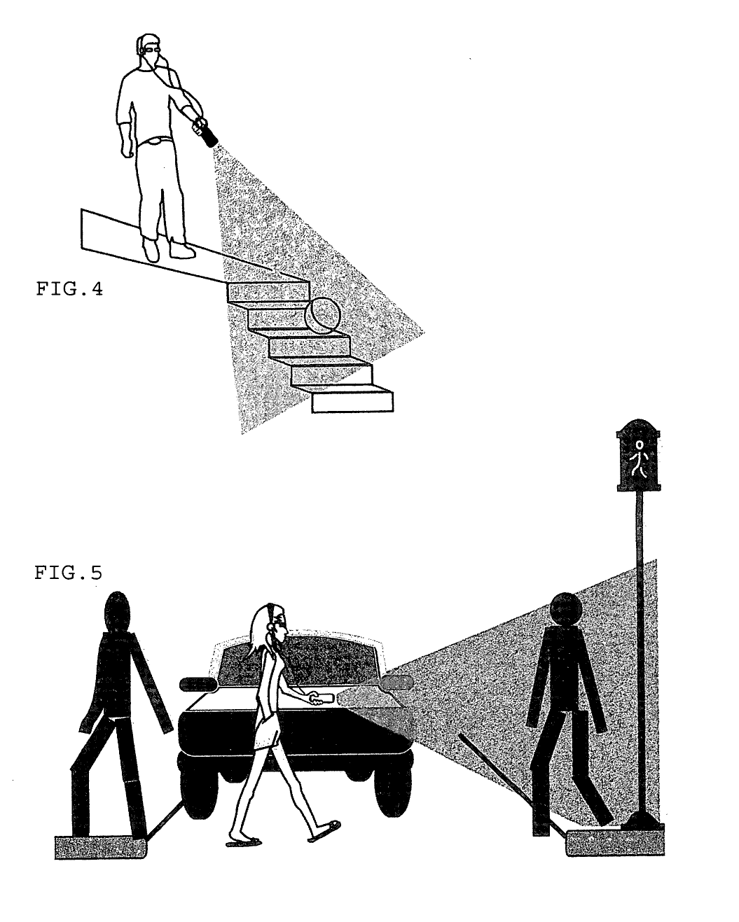

FIG. 5 illustrates system device 1 personal aid and advisor for cross-walk intersection crossings, for allowing detecting, synthesizing, computing, converting or processing captured dimension and image of an object-face, cross-walk transmitter signal, and measured distance to an object for allowing output as an assistive advisory phrase prior to crossing the street in electronic voice.

I claim:

1. An audible distance measurer object-face discriminator cognition stimulant system device housed in a handheld shaft, walking stick, belt attachment, or portable housing, which outputs assistive phrases and measurements in feet, inches, or meters, in electronic voice comprising of:
a) a shaft with embedded object-face recognition video camera;
b) said shaft having embedded distance measurer sensor to pointer end attached thereon;
c} said shaft having embedded GPS locator sensor attached thereon;
d} said shaft having embedded vehicle presence alert system (VPAS) sensor attached thereon;
e) said shaft having embedded restroom-building facility locator sensor attached thereon;
f} said shaft having radio and cellular phone attached therein;
g} said shaft having earphone jack and battery recharging portals attached thereon;
h) said shaft having speaker attached thereon;
i} said shaft having wrist strap attached thereon;
j} said shaft having on/off switch attached thereon;
k} said shaft having radio station selection control attached thereon;
1) said shaft having synthesizer, computer, converter, or processor attached therein;

2. A system device according to claim 1, having a synthesizer, computer, converter, or processor for allowing captured images of an object and measured distance to an object to merge and output as an assistive phrase in electronic voice, attached therein;

3. A system device according to claim 1, and further comprising, having in combination a transmitter adapted for an emergency vehicle such that a vehicle will transmit a signal, and whereas system device VPAS sensor embedded and attached thereon will detect that signal, thus causing synthesizer, computer or processor attached therein to output the phrase “emergency vehicle approaching the vicinity,” in electronic voice there from.

4. A system device according to claim 1, and further comprising, having in combination a transmitter adapted for a building with a restroom such that a building location will transmit a signal, and whereas system device restroom-building locator sensor will detect that signal, thus causing synthesizer, computer, or processor attached therein to output a phrase having the location-direction and distance to that building with a restroom, in electronic voice there from.
